(19) United States
(12) Patent Application Publication
(10) Pub. No.: US 2006/0227918 A1
(43) Pub. Date: Oct. 12, 2006

(54) Specification and testing method for a serial bus device clock recovery circuit

(75) Inventor: Mohammad Kolbehdari, Hillsboro, OR (US)

Correspondence Address: SCHWABE, WILLIAMSON & WYATT, PACWEST CENTER, SUITE 1900, 1211 S.W. FIFTH AVE., PORTLAND, OR, 97204, US

(73) Assignee: Intel Corporation

(21) Appl. No.: 11/105,062

(22) Filed: Apr. 11, 2005

(51) Int. Cl. H04L 12/28; H04J 3/06

(52) U.S. Cl. 375/371; 370/516; 370/395.62

(57) ABSTRACT

A clock recovery circuit testing method, and a serial bus device/system having a clock recovery circuit in compliance with the method are described herein.

### TECHNICAL FIELD & BACKGROUND

The present disclosure is related generally to the field of microelectronics. More specifically but not exclusively, the present disclosure is related to specifying and testing a serial bus clock recovery circuit.

As data transfer rates increase, jitter increasingly contributes to a loss of data between communication devices, in particular, those attached to a high-speed differential signaling serial bus. Jitter can be described as the deviation of some aspect of a pulse in a signal and may affect the amplitude, phase, pulse width or position of pulse. In clock data recovery circuits, in particular, those employed by devices to be attached to a high speed serial bus, jitter can cause an incorrect sampling of data, often leading to functional failure of a device.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a response characteristic curve associated with a specification for a testing method for testing a clock recovery circuit for a receiver of a serial bus agent, in accordance with an embodiment;

FIG. 2 illustrates a jitter transfer function curve, associated with a specification for a testing method for testing a clock recovery circuit for a receiver of a serial bus agent, in accordance with an embodiment;

FIG. 3 illustrates an example serial bus device including a receiver having a clock recovery circuit that may be tested for compliance with the testing method, in accordance with an embodiment;

FIGS. 4 and 5 are example flow diagrams associated with the test method, in accordance with embodiments of the present invention; and

FIG. 6 illustrates an example system, according to an embodiment.

### DETAILED DESCRIPTION OF ILLUSTRATIVE EMBODIMENTS

Embodiments of the present invention include, but are not limited to, a method for testing a clock recovery circuit of a serial bus device wherein the serial bus device including the clock recovery circuit is tested for compliance with a first specification for response to amplitude phase jitters and a second specification for jitter transfer, a serial bus device in compliance with such a testing method, and a system incorporated with the serial bus device.

Various aspects of the illustrative embodiments will be described using terms commonly employed by those skilled in the art to convey the substance of their work to others skilled in the art. However, it will be apparent to those skilled in the art that embodiments of the present invention may be practiced with only some of the described aspects. For purposes of explanation, specific numbers, materials and configurations are set forth in order to provide a thorough understanding of the illustrative embodiments. However, it will be apparent to one skilled in the art that embodiments of the present invention may be practiced without the specific details. In other instances, well-known features are omitted or simplified in order not to obscure the illustrative embodiments.

Various operations will be described as multiple discrete operations, in turn, in a manner that is most helpful in understanding embodiments of the present invention, however, the order of description should not be construed as to imply that these operations are necessarily order dependent. In particular, these operations need not be performed in the order of presentation. The phrase “in one embodiment” is used repeatedly. The phrase generally does not refer to the same embodiment, however, it may. The terms “comprising”, “having” and “including” are synonymous, unless the context dictates otherwise.

In one embodiment, a method for testing a clock recovery circuit of a receiver of a serial bus device for compliance with a specification comprises testing the serial bus device including the clock recovery circuit for compliance with a specification for response to amplitude phase jitters and for compliance with a specification for jitter transfer. In such clock recovery circuits, phase jitter on a signal can often cause functional failure of the serial bus device, due to incorrect sampling of data. In one embodiment, the serial bus device to be tested is a high speed serial bus agent, such as a Peripheral Component Interconnect (PCI) Express bus agent.

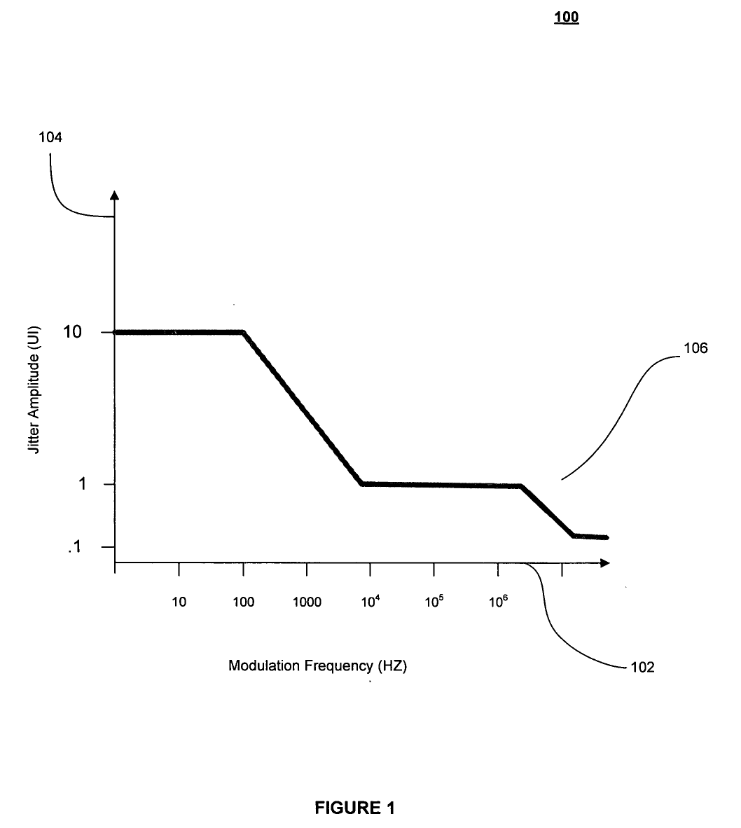

In an embodiment, a first portion of the testing method includes testing the serial bus device for compliance with a specification for response to amplitude phase jitters, as measured according to the serial bus device's bit error rate (BER). Thus, for the embodiment, the specification for response to amplitude phase jitters comprises a response characteristic curve representative of jitter tolerance for the serial bus device, as illustrated by graph 100 in FIG. 1. Graph 100 displays jitter amplitude, as measured in Unit Intervals (UI) on vertical axis 104, versus a signal modulation frequency, as indicated in Hertz (Hz) on horizontal axis 102. In one embodiment, response characteristic curve or response curve 106 specifies a plurality of jitter amplitudes within which an error rate of a serial bus device under test (“DUT”) is to remain under a threshold bit error rate (BER), for a plurality of signal modulation frequencies. Note that in one embodiment, response curve 106 can be determined or defined by adding phase jitter of an increasing amplitude into an “ideal” serial bus device until a selected BER occurs for a signal, the selected BER corresponding to a desired BER threshold for the serial bus DUT. The addition of phase jitter can then be repeated for additional signal modulation frequencies, to find additional jitter amplitude data points on response curve 106.

Accordingly, in an embodiment, testing a serial bus device for compliance with the specification for response to amplitude phase jitters includes testing the serial bus device's response at a plurality of amplitudes for a modulation frequency. As will be discussed in more detail, in an embodiment, a serial bus DUT's response may then be verified by comparing a BER output by the serial bus DUT against response curve 106. Thus, for the embodiment, the serial bus DUT's response at a plurality of amplitudes for a modulation frequency is tested, and then repeated for additional modulation frequencies.

In an embodiment, after the serial bus DUT is tested for compliance with the specification for response to amplitude phase jitters, the serial bus DUT may be tested for compliance with a specification for jitter transfer. In one embodiment, testing of the clock recovery circuit for compliance with the specification for jitter transfer comprises testing the serial bus DUT that includes the clock recovery circuit for compliance with the specification for jitter transfer. In one embodiment, the jitter magnitude or amplitude may be set at a level within the serial bus DUT's jitter tolerance, as defined by response curve 106 of FIG. 1. The jitter transfer function can be described as the ratio of jitter output from a device to the jitter input to the device, as a function of jitter modulation frequency. In an embodiment, by specifying a jitter transfer function, a serial bus device can be tested for compliance with the specification for jitter transfer to test for jitter amplification by components of the serial bus device.

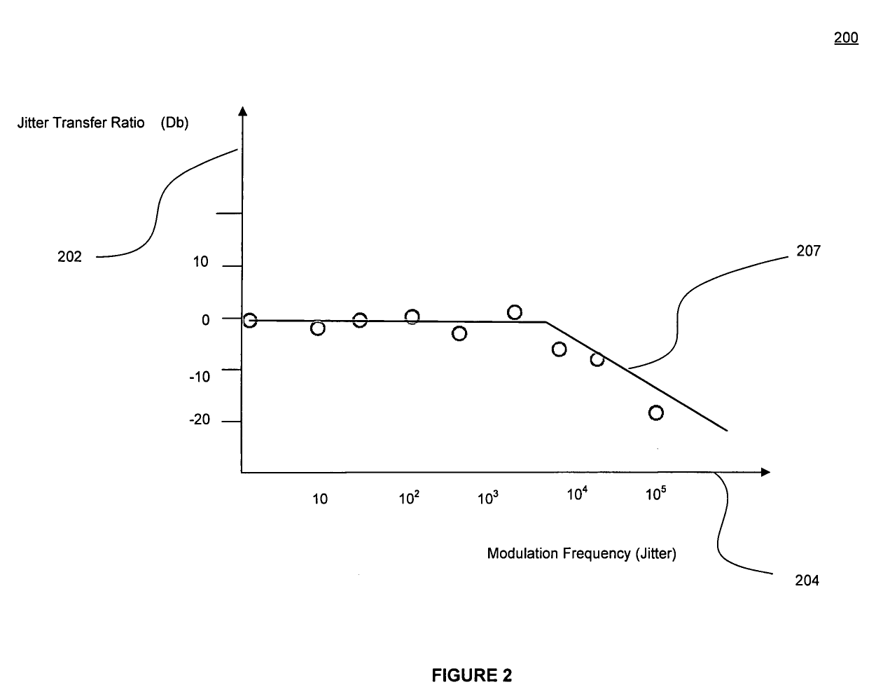

To illustrate, FIG. 2 is a graph 200 including a jitter transfer function curve 207 that may serve as a specification for jitter transfer. In graph 200, a jitter transfer ratio is indicated on vertical axis 202 (in Decibels or Db), while jitter frequency in Hertz (Hz) is indicated on a horizontal axis 204. In an embodiment, jitter transfer function curve 207 can be defined by adding a phase noise to a serial bus device reference clock and measuring a jitter output by the serial bus DUT. As mentioned above, for the embodiment, the jitter amplitude may be set at a level within the serial bus DUT's jitter tolerance, as defined by response curve 106 of FIG. 1. Thus, as shown in FIG. 2, for the embodiment, the specification for jitter transfer comprises a jitter transfer function specifying a plurality of jitter transfer ratio limits of the serial bus DUT, for a plurality of jitter modulation frequencies (Hz). Note that in one embodiment, a serial bus DUT may fail the specification for jitter transfer if its jitter transfer ratio is above or consistently above jitter transfer function curve 207. In the embodiment, a relatively high jitter transfer ratio may indicate a serial bus DUT's gain of jitter and indicate an amplification of jitter by the serial bus DUT or its components.

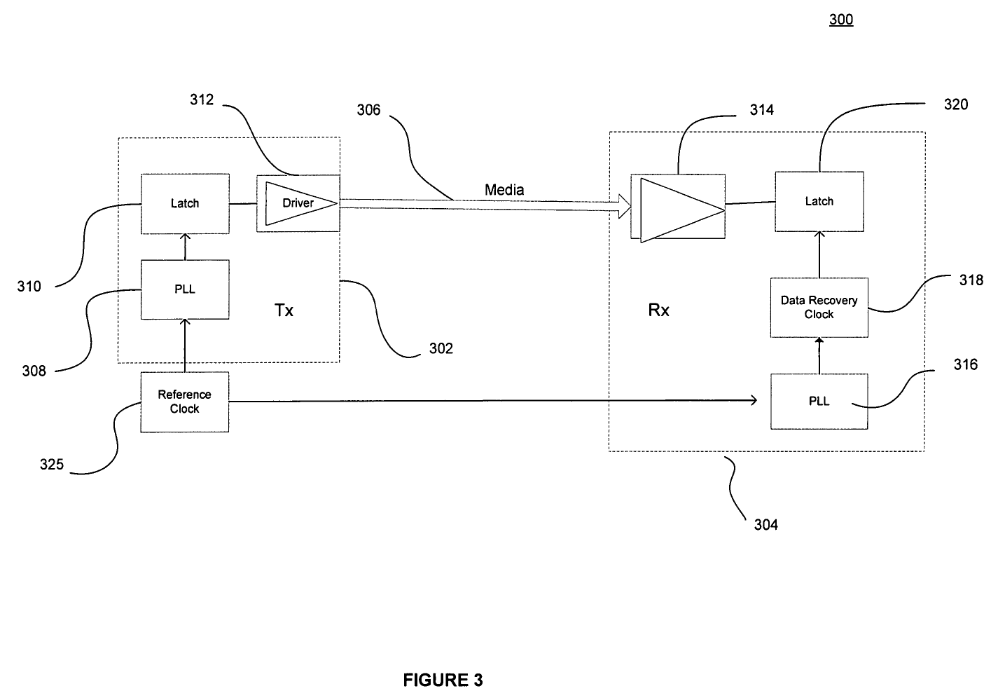

FIG. 3 illustrates a simplified block diagram of an example serial bus device 300 that may be tested using the specifications of FIGS. 1 and 2 above, according to an embodiment. Serial bus device 300 may include various components such as a transmitter (Tx) 302 linked by channel or media 306 to a receiver (Rx) 304. In one embodiment, a reference clock 325 may serve both transmitter 302 and receiver 304. As illustrated, included in transmitter 302 is a transmitter phase-locked loop (PLL) 308 coupled to a transmitter latch 310 and a driver 312. Included in the receiver is a differential amplifier 314, a receiver phase-locked loop 316, a data clock recovery circuit (“DRC”) or clock recovery circuit 318 and a latch 320.

Note that in some cases jitter may be associated with substantially each of the above components of serial bus device 300 and interfere with the ability of clock recovery circuit 318 to properly latch a signal to ensure correct data recovery. Note that in the embodiment, serial bus device 300 may include combinatorial logic (not shown) coupled to latch 320 to process data latched (in accordance with clock recovery circuit 318). In the embodiment, clock recovery circuit 318 may be in compliance with a first specification for response to amplitude phase jitters, and a second specification for jitter transfer, as described in FIGS. 1 and 2, respectively. Note that clock recovery circuit 318 may be in compliance with such specifications as evident by serial bus device 300 being in compliance with the respective first and second specifications.

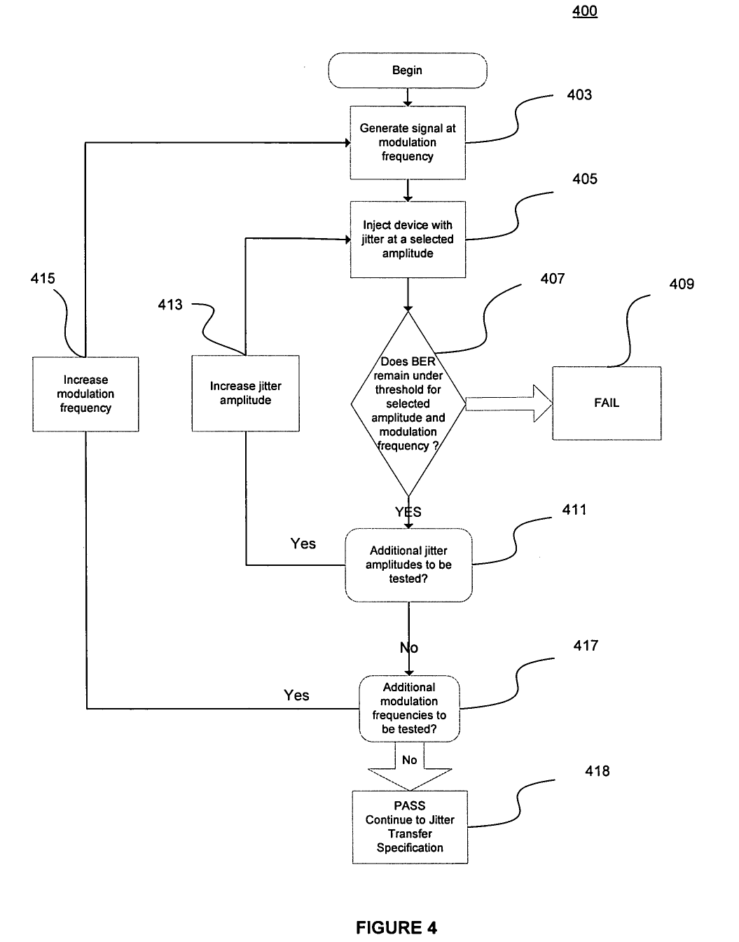

FIG. 4 is a simplified flow diagram 400 further illustrating the testing of a clock recovery circuit of a device, such as of serial bus device 300 for compliance with a specification for response to amplitude phase jitters. In an embodiment, at a block 403, a signal may be generated at a selected modulation frequency. For the embodiment, the modulation frequency selected corresponds to a point along a response characteristic curve, such as for example, response curve 106 of FIG. 1. At a next block 405, the serial bus device or serial bus DUT may be injected with jitter at a selected amplitude. In an embodiment, the selected amplitude corresponds to one of a plurality of jitter amplitudes below response curve 106 at the selected modulation frequency. Next, at a decision block 407, if the BER of the serial bus DUT does not remain under a BER threshold for response curve 106, the serial bus DUT may fail the specification at a block 409.

If, however, the BER does remain at or below the threshold, the process flows to a block 411, where it is determined whether additional amplitudes are to be tested. If so, the jitter amplitude may be increased at a block 413 and the process returns to block 405. After a plurality of amplitudes have been tested, the determination of whether additional amplitudes are to be tested may be negative. The process may then continue to a block 417, where it is determined whether an additional modulation frequency is to be tested. If so, the modulation frequency will be increased at a block 415 and the operations as described above repeat. In an embodiment, upon a determination at block 417 that there are no additional modulation frequencies to be tested, the serial bus DUT may pass the response to amplitude phase jitters specification at a block 418. As will be discussed below, for the embodiment, the serial bus DUT may then be tested for compliance with a specification for jitter transfer.

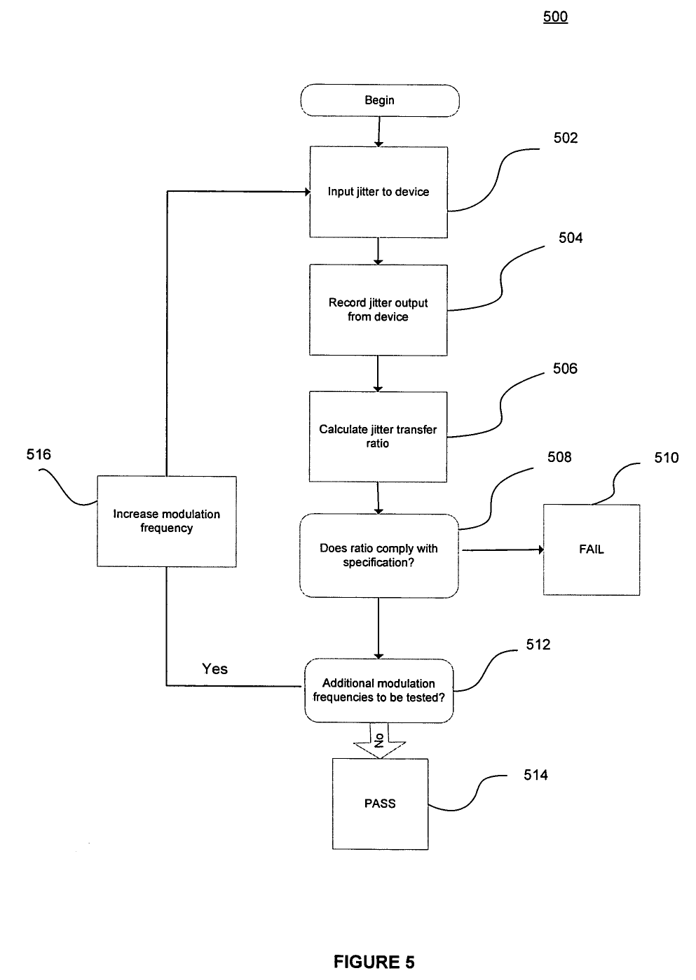

Referring now to FIG. 5, where a simplified flow diagram of a process associated with testing a serial bus DUT for compliance with a specification for jitter transfer, in accordance with an embodiment, is shown. At a block 502, jitter may be injected or input to the serial bus DUT. In an embodiment, the magnitude or amplitude of jitter injected may be defined according to a response curve such as response curve 106 of FIG. 1. Next, in an embodiment, jitter output from the serial bus DUT may be measured and recorded at a block 504. A jitter transfer ratio may then be calculated at a block 506. At a next block 508, the jitter transfer ratio of the serial bus DUT may be compared to the specification for jitter transfer for the jitter modulation frequency. If the jitter transfer ratio of the serial bus DUT does not comply with the jitter transfer ratio limit of the specification, the serial bus DUT may fail at a block 510. If the jitter transfer ratio does comply, the process flows to a decision block 512, where it is determined whether there are additional jitter modulation frequencies to be tested. If so, the jitter modulation frequency may be increased at a block 516 and the process loops to block 502 to repeat the above described events.

After the testing of the serial bus DUT's jitter transfer ratio for a jitter modulation frequency has been repeated for a plurality of jitter modulation frequencies, the determination of whether additional modulation frequencies are to be tested may be negative. If so, the serial bus DUT may pass the response to jitter transfer specification at a block 514. Note that in another embodiment, a jitter transfer function of the serial bus DUT may be taken in its entirety before determining whether the serial bus DUT has passed or failed compliance with the specification for jitter transfer. In an embodiment, if the jitter transfer ratio is not constant or decreasing at points substantially consistent with the specification for jitter transfer, an amplification of jitter may be indicated and the serial bus DUT may fail the specification for jitter transfer.

Further note that in an embodiment, a jitter transfer function may also be taken for individual components of the serial bus DUT and subsequently added together. In an embodiment, individual components of the serial bus DUT may include components such as but not limited to, reference clock 325, latches 310 and 320, driver 312, Tx and Rx PLL's 308 and 316, differential amplifier 314, media 306 (see FIG. 3.), as well as packages associated with receiver 304 and transmitter 302. Additionally, note that although the specification for response to amplitude phase jitters and the specification for jitter transfer have been illustrated as curves or as data represented graphically, in various embodiments, the data contained in the specifications may also be represented in various forms, such as for example, in data lists or tables.

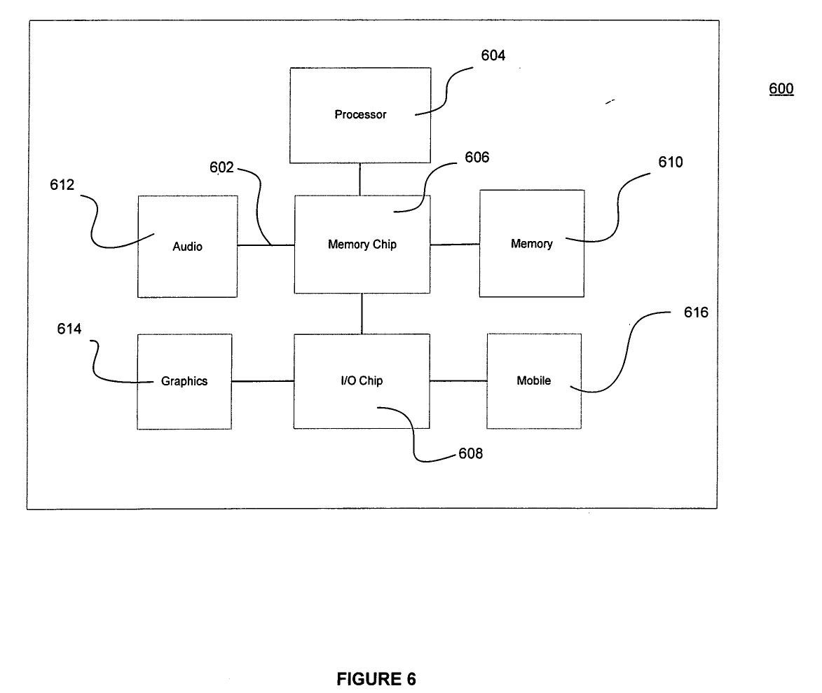

FIG. 6 illustrates an example system 600 in accordance with an embodiment. In one embodiment, system 600 includes a serial bus 602 coupled to a processor 604, a memory chip 606, an Input/Output (I/O) chip 608, a memory 610, and one or more peripheral devices. In various embodiments, serial bus 602 may be a PCI-Express bus, and one or more peripheral devices may include but are not limited to a PCI-Express audio 612, graphics 614 or mobile 616. In an embodiment, at least one the one or more serial bus devices may includes a clock recovery circuit, the clock recovery circuit being in compliance with a first specification for response to amplitude phase jitters, and a second specification for jitter transfer. In one embodiment, transmitter 302 and receiver 304 of FIG. 3 may be included in one or more of the chips or peripheral devices and media 306 may serve as a transmission path for data between the one or more chips or devices.

In various embodiments, system 600 may be a desktop computer, a laptop computer, a tablet computer, a palm-sized computing device, a set-top box, a mobile phone, a digital camera, a media player, or a CD/DVD player.

Thus, it can be seen from the above descriptions, one or more novel methods for testing a clock recovery circuit of a serial bus device have been described. A serial bus device in compliance with such a testing method, and a system incorporated with the serial bus device have also been described. While the present invention has been described in terms of the foregoing embodiments, those skilled in the art will recognize that the invention is not limited to the embodiments described. Embodiments of the present invention can be practiced with modification and alteration within the spirit and scope of the appended claims. Accordingly, the description is to be regarded as illustrative instead of restrictive on embodiments of the present invention.

What is claimed is:

1. A method for testing a clock recovery circuit of a serial bus device, comprising:
testing the serial bus device for compliance with a specification for response to amplitude phase jitters; and
testing the serial bus device for compliance with a specification for jitter transfer.

2. The method of claim 1, wherein the testing of the serial bus device for compliance with the specification for response to amplitude phase jitters comprises testing the serial bus device for compliance with a response characteristic curve specifying a plurality of jitter amplitudes within which an error rate of the serial bus device is to remain under a threshold, for a plurality of modulation frequencies.

3. The method of claim 2, wherein the testing of the serial bus device for compliance with the specification for response to amplitude phase jitters comprises testing the serial bus device's response at a plurality of amplitudes for a modulation frequency.

4. The method of claim 3, wherein the testing of the serial bus device for compliance with the specification for response to amplitude phase jitters further comprises repeating the testing of the serial bus device's response at a plurality of amplitudes for a modulation frequency, for a plurality of modulation frequencies.

5. The method of claim 1, wherein the testing of the serial bus device for compliance with a specification for jitter transfer comprises testing for compliance with a transfer function specifying a plurality of jitter transfer ratio limits, for a plurality of jitter modulation frequencies.

6. The method of claim 5 wherein the testing of the serial bus device for compliance with the specification for jitter transfer comprises testing the serial bus device that includes the clock recovery circuit for compliance with the specification for jitter transfer.

7. The method of claim 6, wherein the testing of the serial bus device that includes the clock recovery circuit for compliance with the specification for jitter transfer comprises testing the serial bus device's jitter transfer ratio for a jitter modulation frequency.

8. The method of claim 7, wherein the testing of the serial bus device that includes the clock recovery circuit for compliance with the specification for jitter transfer further comprises repeating the testing of the serial bus device's jitter transfer ratio for a jitter modulation frequency, for a plurality of jitter modulation frequencies.

9. The method of claim 1, wherein the device is a PCI Express bus agent.

10. A serial bus device, comprising:
a receiver including a latch; and
the receiver further having a clock recovery circuit coupled to the latch, the clock recovery circuit being in compliance with a specification as evident by the serial bus device in compliance with a first specification for response to amplitude phase jitters, and a second specification for jitter transfer.

11. The device of claim 10 wherein the first specification for response to amplitude phase jitters comprises a response characteristic curve specifying a plurality of jitter amplitudes within which an error rate of the serial bus device is to remain under a threshold, for a plurality of modulation frequencies.

12. The device of claim 11 wherein the serial bus device comprises at least one of a Peripheral Control Interface-Express audio device, graphics device or mobile device.

13. The device of claim 10, wherein the second specification for jitter transfer comprises a transfer function specifying a plurality of jitter transfer ratio limits, for a plurality of jitter modulation frequencies.

14. The device of claim 10, wherein the serial bus device has a jitter transfer ratio in compliance with the second specification for jitter transfer for a jitter modulation frequency, for a plurality of jitter modulation frequencies.

15. A system comprising
a serial bus;
a processor coupled to the serial bus;
a serial bus device coupled to the serial bus, the serial bus device including:
a receiver having a latch;
the receiver further having a clock recovery circuit coupled to a circuit element, the clock recovery circuit being in compliance with a specification, as evident by the serial bus device being in compliance with a first specification for response to amplitude phase jitters, and a second specification for jitter transfer; and
a mass storage device coupled to the serial bus.

16. The system of claim 15, wherein the first specification for response to amplitude phase jitters comprises a response characteristic curve specifying a plurality of jitter amplitudes within which an error rate of the serial bus device is to remain under a threshold, for a plurality of modulation frequencies.

17. The system of claim 15 wherein the specification for jitter transfer comprises a transfer function specifying a plurality of jitter transfer ratio limits, for a plurality of modulation frequencies.

18. The system of claim 17, wherein the serial bus comprises a Peripheral Control Interface-Express bus.

19. The system of claim 15, where the system is one selected from the group consisting of a digital camera, a mobile phone and a media player.
